(19) United States
(12) Patent Application Publication
(10) Pub. No.: US 2013/0336255 A1
(43) Pub. Date: Dec. 19, 2013

(54) METHOD AND SYSTEM FOR DECODING PDCCH IN A MULTI-CARRIER LTE-ADVANCE SYSTEM

(71) Applicant: Samsung Electronics Co., Ltd., Gyeonggi-do (KR)

(72) Inventors: Ashish Kumar GUPTA, Bangalore-93 (IN); Sudhirkumar BAGHEL, Bangalore-37 (IN)

(21) Appl. No.: 13/921,801

(22) Filed: Jun. 19, 2013

(30) Foreign Application Priority Data
Jun. 19, 2012 (IN) 2420/CHE/2012

(51) Int. Cl. H04W 28/06

(52) U.S. Cl. CPC H04W 28/06
USPC 370/329; 370/328

(57) ABSTRACT

A method and system to decode PDCCH in LTE advanced systems is disclosed. The method adds the adjacent carrier information as LTE-Advanced bits in the PDCCH. The method proposes two approaches such as circular linked list and scrambled approach in adding the adjacent carrier information in the PDCCH. These approaches provide information of all the scheduled PDCCH for an UE. A circular linked list informs the starts position of adjacent PDCCH where UE has its data. Scrambling approach has all the scheduled PDCCH information in current carrier with different scrambling code which is known by the UE. Therefore, by decoding only current carrier UE knows PDCCHs that are scheduled for its data. The method reduces the complexity to a great extent with increase in little overhead.

### PRIORITY

This application claims priority under 35 U.S.C. §119(a) to Indian Patent Application No. 2420/CHE/2012, which was filed in the Indian Patent Office on Jun. 19, 2012, the entire content of which is incorporated herein by reference.

### BACKGROUND OF THE INVENTION

1. Field of the Invention

The present invention relates mobile communication technology and more particularly relates to reduction of complexity and overhead involved in decoding of a Physical Downlink Control CHannel (PDCCH) for a Long Term Evolution (LTE) Advance system.

2. Description of the Related Art

Wireless communication systems are evolving constantly. Further, the designers are continuously developing greater number of features for both network operators as well as to the end users. In the area of wireless phone systems, cellular based phone systems have advanced tremendously in recent years.

The 3rd Generation Partnership Project (3GPP)/3GPP2 is collaboration between groups of telecommunications associations, known as the Organizational Partners. The initial scope of 3GPP was to make a globally applicable third-generation (3G) mobile phone system specification based on evolved Global System for Mobile Communications (GSM) specifications within the scope of the International Mobile Telecommunications-2000 project of the International Telecommunication Union (ITU). 3GPP is developing Rel. 10 specification also known as LTE-Advanced to meet and exceed the requirements of IMT-Advanced. Further, to increase the data rate 100 MHz bandwidth is proposed and to utilize this bandwidth efficiently, carrier aggregation (i.e. assigned bandwidth can be spread at multiple carrier) has been introduced. Hence, User Equipment (UE) can obtain its data on multiple carriers at same time. All the component carriers for 3GPP LTE-Advanced Rel-10 are compatible with Rel-8/9.

Further, to obtain data User Equipment (UE) should know its control information and resource allocation for each component carrier on which it has been scheduled. For this problem, Rel. 10 has proposed the concept of blind decoding in several approaches. In one approach, all the bands have individual PDCCH for UE. In order to obtain the data, the UE has to scan all the bands which consume more power and increases overhead. Further, scanning all the bands to obtain the PDCCH is a complicated process and may not be efficient in real time scenarios.

In another approach, there exists primary and secondary PDCCH which are intended for the UE. Further, primary PDCCH knows the carriers of secondary PDCCH and UE has secondary PDCCHs in all the assigned carriers. In this case, if the primary PDCCH is lost, UE is not able to find secondary PDCCHs and therefore this approach does not reduce the complexity in blind decoding.

In yet another approach, UE has primary and secondary PDCCH. Further, secondary PDCCH has control information of all bands. This requires more bandwidth to accommodate a large PDCCH within a secondary PDCCH, leading to an overhead and blind decoding complexity.

Due to above mentioned reasons, it is evident that the concept of blind decoding by the UE increases overhead, computation complexity and dependency on primary-secondary bands. Further, a proper design of PDCCH that reduces complexity, dependency on primary-secondary and overhead is needed.

### SUMMARY OF THE INVENTION

The present invention has been made to address at least the above problems and/or disadvantages and to provide at least the advantages described below. The principal object of the embodiments herein is to provide a method and system for decoding the PDCCH to reduce the complexity and overhead.

Another object of the invention is to provide a circular linked list approach for decoding PDCCH with reduced complexity and overhead.

Another object of the invention is to provide a scrambling based approach for decoding PDCCH with reduced complexity and overhead.

Accordingly the invention provides a method to decode PDCCH (Physical Downlink Control Channel) in LTE (Long Term Evolution) advanced systems, wherein the method comprises, adding information to PDCCH of current carrier by a base station, wherein the information comprises PDCCH of carrier adjacent to the current carrier, sending the PDCCH by the base station to plurality of user equipments (UEs), decoding the PDCCH by at least one UE from the plurality of UEs and identifying the adjacent carrier information from the PDCCH by the UE.

Accordingly the invention provides a base station in a communication network, wherein the base station is configured for adding information to PDCCH of current carrier, wherein the information comprises PDCCH of carrier adjacent to the current carrier, sending the PDCCH to plurality of user equipments (UEs).

Accordingly the invention provides a user equipment (UE) for decoding PDCCH (Physical Downlink Control Channel) in LTE (Long Term Evolution) advanced systems, wherein the UE is configured for identifying added information to PDCCH in current carrier among the plurality of carriers sent by a base station.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following description with reference to the drawings, in which:

FIG. 1 is a general block diagram showing the communication between the base station and multiple user equipment, according to embodiments as disclosed herein;

FIG. 2 is a block diagram showing several modules present in the user equipment, according to embodiments as disclosed herein;

FIG. 3A illustrates the LTE-Advance PDCCH format for circular linked list approach, according to embodiments as disclosed herein;

FIG. 3B illustrates the circular linked list of scheduled bands, according to embodiments as disclosed herein;

FIG. 4 illustrates the LTE-Advanced sub frames, according to embodiments as disclosed herein;

FIG. 5 is a flow diagram illustrating the circular linked list approach, according to embodiments as disclosed herein;

FIG. 6 illustrates scrambling approach, according to embodiments as disclosed herein; and

FIG. 7 is a flow diagram illustrating the scrambling approach, according to embodiments as disclosed herein.

### DETAILED DESCRIPTION OF EMBODIMENTS OF THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a method and system for decoding the PDCCH in LTE-Advanced system with reduced complexity and overhead. The method provides a tradeoff between complexity and overhead in decoding PDCCH for LTE Advanced system. A base station sends the PDCCH (Physical Downlink Control Channel) to multiple user equipments (UEs). In case of carrier aggregation in the LTE-Advanced, UE need to blindly decode the PDCCH in all component carriers. In the proposed method, the base station adds the adjacent carrier information to PDCCH of current carrier, and sends it to multiple UEs. The adjacent carrier information is added to all the component carriers. The adjacent carrier information refers to the PDCCH location. The UE on receiving the PDCCH, from base station will initially decode the PDCCH information in the first carrier and then identifies the information of adjacent carrier. Thus, the UE can identify its control information and resource allocation by locating the resource blocks in the PDCCH.

The Base Station may also be called by another terminology, such as an eNB (evolved NodeB), a BTS (Base Transceiver System), an access point, or an AN (Access Network). The Base Station may perform functions, such as connectivity, management, control, and resource allocation with the UE.

The User Equipment may be fixed or mobile and may also be called another terminology, MS (Mobile Station), an UT (User Terminal), an SS (Subscriber Station), a wireless device, a PDA (Personal Digital Assistant), a wireless modem, a handheld device, or an AT (Access Terminal).

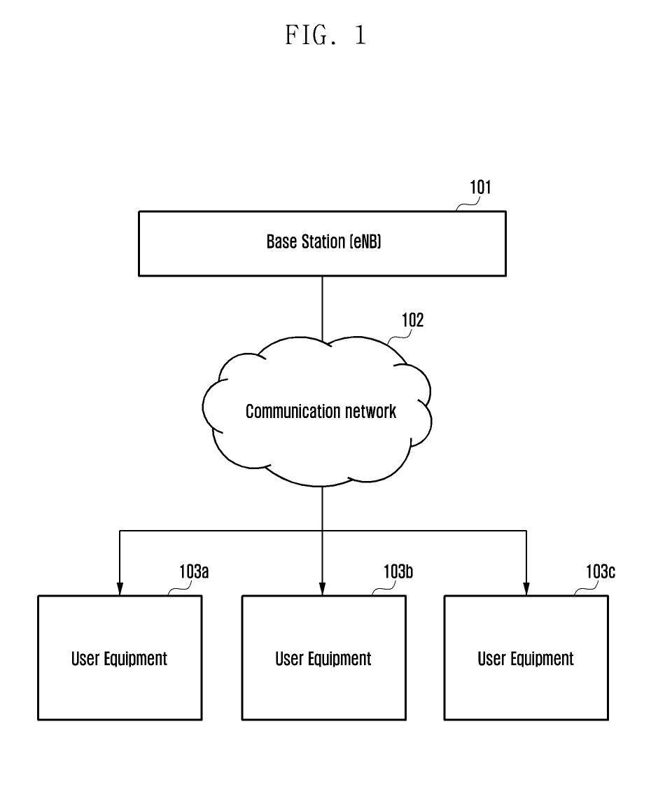

Referring now to the drawings, and more particularly to FIGS. 1 through 7, where similar reference characters denote corresponding features consistently throughout the figures, there are shown preferred embodiments.

FIG. 1 is a general block diagram showing the communication between the base station and multiple user equipment, according to embodiments as disclosed herein. As depicted in the figure the eNB and the user equipment device communicate wirelessly. The eNB 101 is connected through the communication network 102 to multiple UEs such as 103a, 103b and 103c. The communication network 102 is based on cellular technology like 3GPP LTE and its evolution LTE-Advanced. The communication network 102 may be based on other cellular technologies like WiMAX, CDMA and so on. The eNB 101 sends and receives communication signals from the user equipment devices 103a, 103b and 103c. There may be any number of UE devices communicating with the eNB 101.

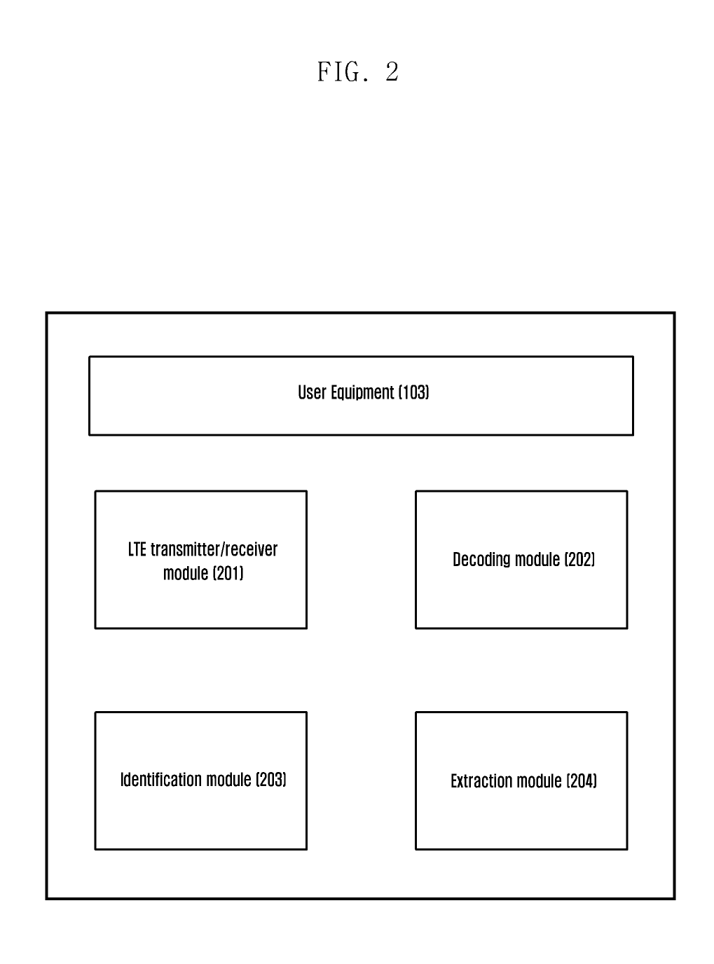

FIG. 2 is a block diagram showing several modules present in the user equipment, according to embodiments as disclosed herein. As depicted in the figure, the user equipment 103 comprises several modules such as LTE transmitter/receiver module 201, a decoding module 202, an identification module 203 and an extraction module 204 in itself and capable of communicating with the eNB 101. The LTE transmitter/receiver module 201 in the UE 103 transmits and receives LTE signals to and from the eNB 101. The decoding module 202 decodes the PDCCH in all component carriers sent from the eNB 101. In an embodiment, the eNB 101 sends the adjacent carrier information along with the PDCCH to the UE. The identification module 203 in the UE identifies the adjacent carrier information in the PDCCH. In an embodiment, the eNB 101 sends the control and data information in the LTE-Advanced sub frames. The extraction module 204 in the UE extracts the control and data information in the sub frames.

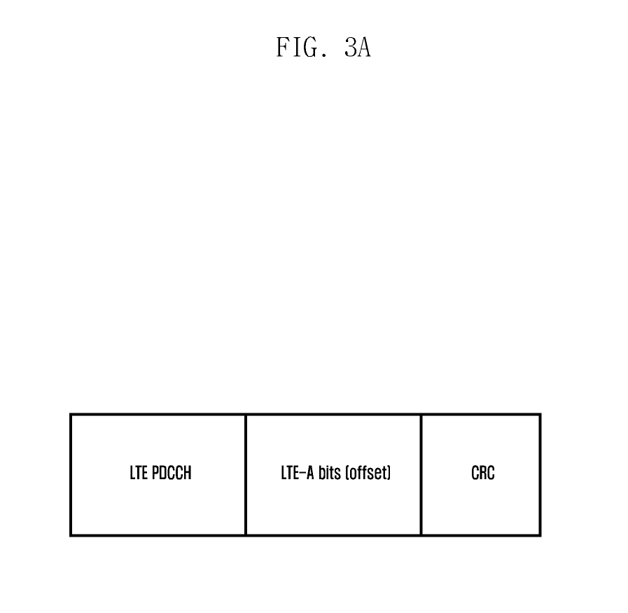

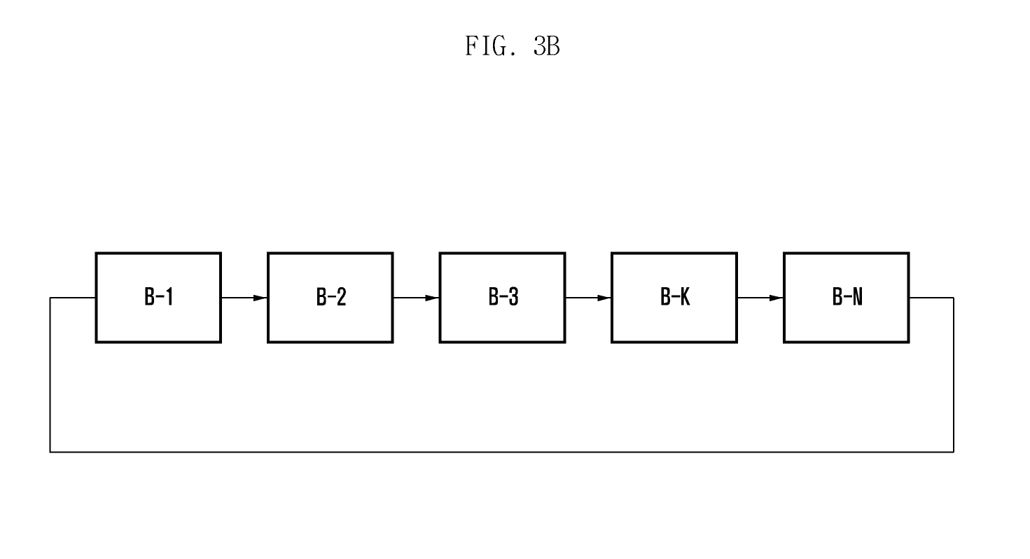

FIG. 3A illustrates the LTE-Advance PDCCH format for circular linked list approach, according to embodiments as disclosed herein. As depicted in the figure, the LTE-Advanced PDCCH format includes LTE PDCCH, LTE-A bits and a cyclic redundancy check (CRC). The LTE-A bits with offset are added to the LTE PDCCH. Further, the LTE-Advanced PDCCH contains few more bits than LTE PDCCH. LTE-A bits has the location information of PDCCH in the adjacent carrier. Also, LTE-A bits has the linking offset, subcarrier and OFDM symbol information.

In one embodiment, the offset information of LTE-A bits include the correct location which contains time and frequency of PDCCH. This offset information is added in the PDCCH format along with the CRC.

An eNodeB determines a PDCCH format according to Downlink Control Information (DCI) to be transmitted to multiple UEs and attaches CRC (Cyclic Redundancy Check) to the DCI. A unique identifier (called an RNTI (Radio Network Temporary Identifier)) is masked to the CRC. If a PDCCH is for a specific UE, a unique identifier (e.g., a C-RNTI (Cell-RNTI)) of the UE may be masked to the CRC.

FIG. 3A illustrates the circular linked list of scheduled bands, according to embodiments as disclosed herein. As shown in the figure, the bands B-1, B-2, B-3 . . . B-K and B-N are connected to each other, forming a linked list. The PDCCH in one band has the information of PDCCH in adjacent band and so on. Further, the PDCCH in the last band B-N is linked with the first band B-1 making it as a circular linked list. All the bands are transmitted to the UEs in a predetermined sequence as decided by the eNB.

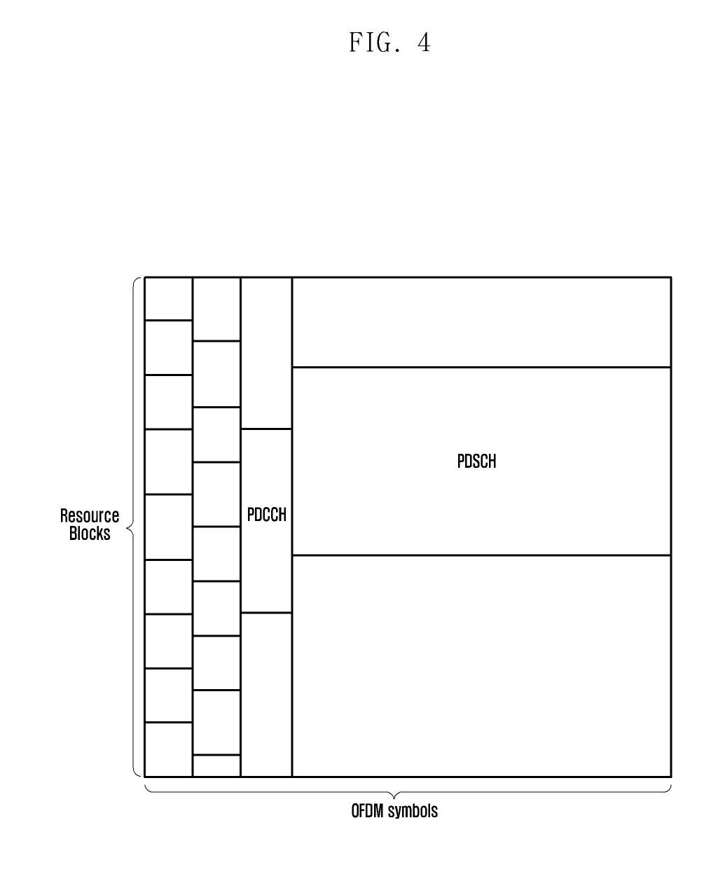

FIG. 4 illustrates the LTE-Advanced sub frames, according to the embodiments as disclosed herein. As depicted in the figure, a sub frame holds the Resource Blocks (RBs), OFDM symbols and PDSCH data. In a sub frame, PDCCH can be anywhere in the first three OFDM symbols. Once the UE identifies the PDCCH in a particular OFDM symbol, it will extract the appropriate location of the Resource Blocks (RBs). Further, 2 bits in LTE-A bits are used to indicate the OFDM symbol which is used for scheduled PDCCH. This reduces the blind decoding of PDCCH in other OFDM symbol, thereby reducing the complexity up to one third from prior LTE structure.

In one embodiment, the OFDM symbols that hold PDCCH information is divided into ‘n’ number of Resource Blocks (RBs), where n is an integer. For example, if there exist 100 RB, they are divided into a group of 6RB and there will be 4 bits to represent a single group of RB.

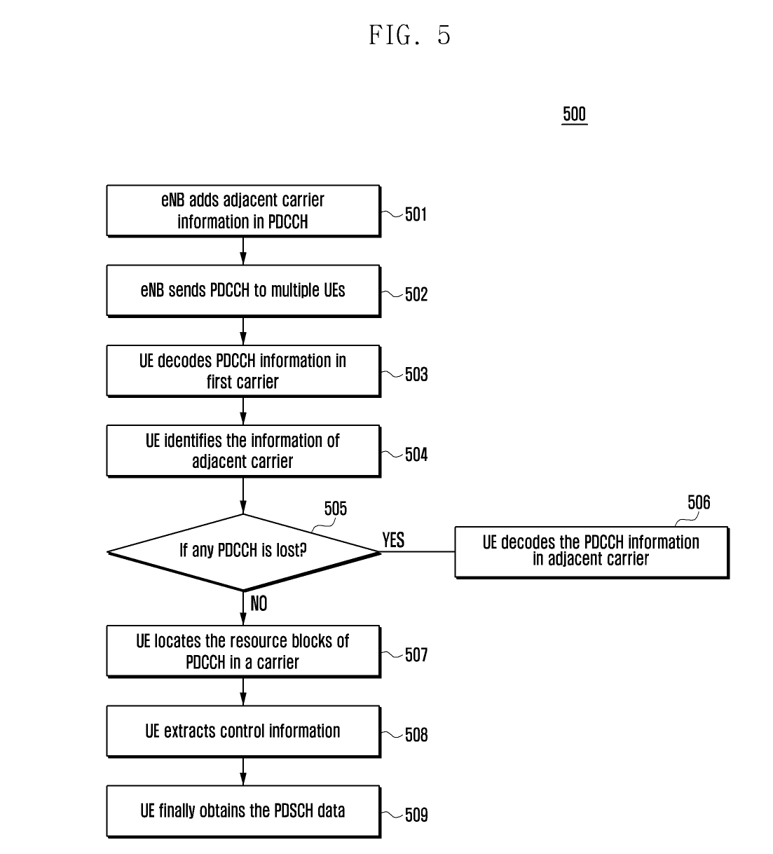

FIG. 5 is a flow diagram illustrating the circular linked list approach, according to embodiments as disclosed herein. As depicted in the FIG. 500, the eNB adds (501) the adjacent carrier information in PDCCH. In an embodiment, the LTE-Advanced PDCCH has few more bits that LTE PDCCH. The LTE-Advanced bits comprise location information of PDCCH in the adjacent carrier and this information is added to the LTE PDCCH. In an embodiment, the adjacent carrier information is appended to the PDCCH of current carrier. Then the eNB sends (502) the PDCCH to multiple UEs. In an embodiment, the eNB adds the LTE-Advanced bits to PDCCH in multiple carriers which are circularly linked to each other. Then the eNB sends the multiple carriers to multiple UEs. Further, the UE initially decodes (503) the PDCCH information in the first carrier among multiple carriers sent by the eNB. UE identifies (504) the information of adjacent carrier from the added LTE-Advanced bits. For example, the eNB send 4 carriers to the UE. Now, the UE need to decode the 1st carrier and identifies the 2nd carrier information added in the first carrier connected in a circular linked list. Then the UE decodes the 2nd carrier information and identifies the information of the 3rd carrier. Then the UE decodes the 3rd carrier information and identifies the information of the 4th carrier. Then 4th carrier is linked to the 1st carrier. Finally, the UE completes the circular linked list by again decoding the information in the 1st carrier. The UE checks (505) whether any PDCCH is lost in the circular linked list. In an embodiment, if the UE identifies any PDCCH is lost, then the UE will decode (506) the PDCCH information of the adjacent carrier and by knowing the adjacent carrier information UE can again follow the circular linked list approach to identify the PDCCH information in the carrier.

In an embodiment, a sub frame includes two slots. A maximum of 3 OFDM symbols of a first slot within the sub frame correspond to a control information to which control channels are allocated, and the remaining OFDM symbols correspond to a data region to which PDSCHs (Physical Downlink Shared Channels) are allocated. The PDCCH can be anywhere in the first 3 OFDM symbol, hence 2 bits in LTE-Advance are used to indicate the OFDM symbol which is used for scheduling the PDCCH. Next bits are used to locate the resource blocks of PDCCH in that sub frame. In an embodiment, the UE locates (507) the resource blocks of PDCCH in a carrier.

In an embodiment, one downlink slot can include 7 OFDM symbols and one resource block includes 12 subcarriers in the frequency domain. Each of elements on the resource grid is called a resource element. One resource block includes 12.times.7 resource elements. The number of resource blocks included in a downlink slot depends on a downlink transmission bandwidth configuration in a cell.

Further, the UE extracts (508) the control information in the sub frame. In an embodiment, the control information comprises modulation coding scheme (MCS), resource allocation (RA) and so on. After extracting the control information that corresponds to the UE, it obtains (509) the PDSCH data in the data region of the sub frame. In an embodiment, the PDSCH comprises user data, transport block size (TBS) and so on. The various actions in method 500 may be performed in the order presented, in a different order or simultaneously. Further, in some embodiments, some actions listed in FIG. 5 may be omitted.

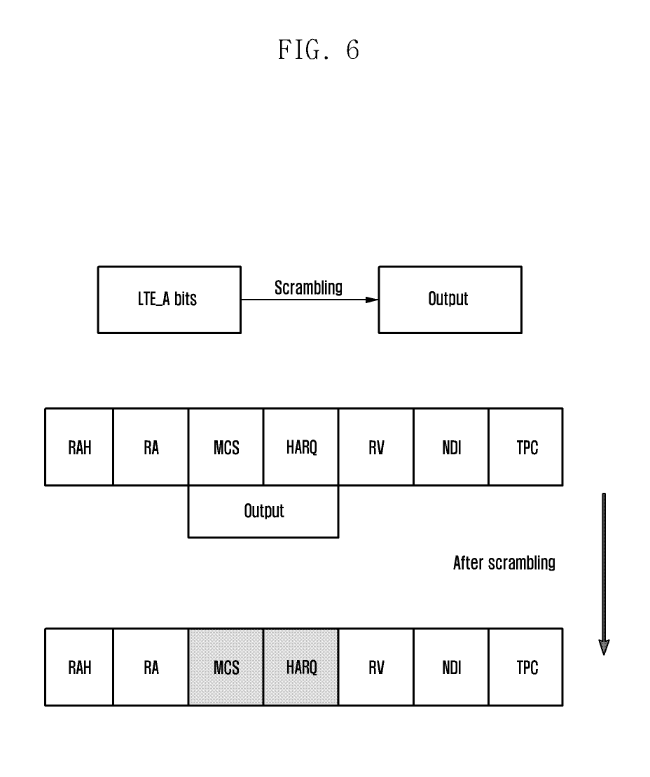

FIG. 6 illustrates scrambling approach, according to embodiments as disclosed herein. As depicted in the figure, the LTE-Advanced bits which comprise offset information such as time and frequency of the adjacent carrier information are scrambled and the output is added in the PDCCH. In an embodiment, the scrambling is based on a unique scrambling sequence which is known by the UE. If UE is scheduled in many bands, the LTE-Advanced bits for corresponding bands are scrambled with this unique sequence. In PDCCH, resource allocation (RA) size is not fixed and it depends on the bandwidth. Hence, the number of bits will vary for the resource allocation. However, MCS (modulation coding scheme), HARQ (Hybrid Automatic Repeat Request) bits are fixed, therefore the scrambled output are mapped on these bits as shown in the figure.

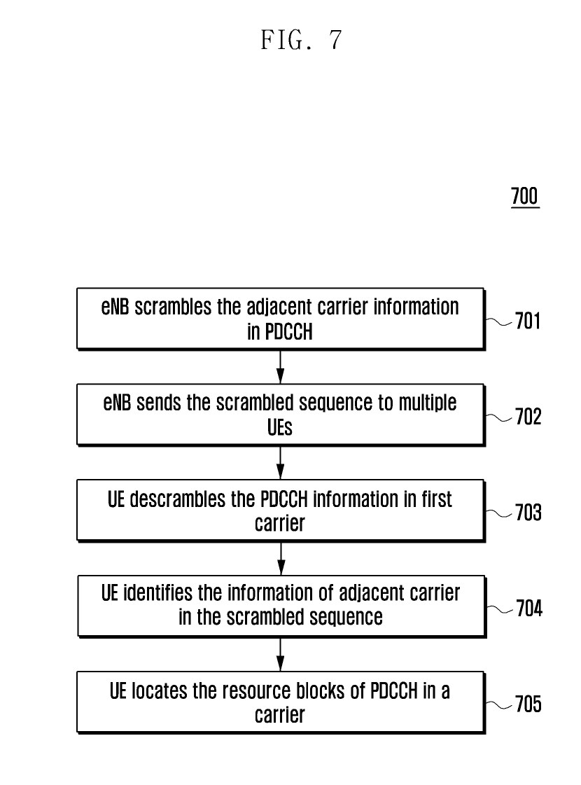

FIG. 7 is a flow diagram illustrating the scrambling approach, according to embodiments as disclosed herein. As depicted in the FIG. 700, eNB scrambles (701) the adjacent carrier information in PDCCH. Then the eNB sends (702) the scrambled sequence to multiple UEs. In an embodiment, the eNB adds the scrambled sequence specific to UEs. UE on receiving the scrambled sequence descrambles (703) the PDCCH information in first carrier. Then the UE identifies (704) the adjacent carrier information in the scrambled sequence. Finally, the UE locates (705) the resource blocks of PDCCH in a carrier. The various actions in method 700 may be performed in the order presented, in a different order or simultaneously. Further, in some embodiments, some actions listed in FIG. 7 may be omitted.

The embodiments disclosed herein can be implemented through at least one software program running on at least one hardware device and performing network management functions to control the elements. The elements shown in FIGS. 1 and 2 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method to decode PDCCH (Physical Downlink Control Channel) in LTE (Long Term Evolution) advanced systems, wherein said method comprises:
adding information to PDCCH of current carrier by a base station, wherein said information comprises PDCCH of carrier adjacent to said current carrier;
sending said PDCCH by said base station to plurality of user equipments (UEs);
decoding said PDCCH by at least one UE from said plurality of UEs; and
identifying said adjacent carrier information from said PDCCH by said UE.

2. The method as in claim 1, wherein said method comprises adding information to PDCCH of current carrier comprises of appending said information to said PDCCH of said current carrier.

3. The method as in claim 1, wherein said PDCCH of said current carrier points to PDCCH of first carrier allocated by said base station, when said current carrier is last carrier allocated by said base station.

4. The method as in claim 1, wherein said adjacent carrier information comprises location of PDCCH.

5. The method as in claim 4, wherein said location of PDCCH comprises at least one of a time or frequency.

6. The method as in claim 1, wherein said adding information to PDCCH of current carrier comprises of adding said information as a sequence within said PDCCH.

7. The method as in claim 1, wherein said decoding comprises of descrambling said information, when said information is added as a scrambled sequence within said PDCCH.

8. A base station in a communication network, wherein said base station is configured for
adding information to PDCCH of current carrier, wherein said information comprises PDCCH of carrier adjacent to said current carrier;
sending said PDCCH to plurality of user equipments (UEs).

9. The base station as in claim 8, wherein said base station is configured for adding information to PDCCH of current carrier comprises of appending said information to said PDCCH of said current carrier.

10. The base station as in claim 8, wherein said PDCCH of said current carrier points to PDCCH of first carrier allocated by said base station, when said current carrier is last carrier allocated by said base station.

11. The base station as in claim 8, wherein said adjacent carrier information comprises location of PDCCH.

12. The base station as in claim 8, wherein said base station is configured for adding information to PDCCH of current carrier comprises of adding said information as a sequence within said PDCCH.

13. A user equipment (UE) for decoding PDCCH (Physical Downlink Control Channel) in LTE (Long Term Evolution) advanced systems, wherein said UE is configured for
identifying added information to PDCCH in current carrier among the plurality of carriers sent by a base station.

14. The UE as in claim 13, wherein said UE identifies said added information comprises information of adjacent carrier.

15. The UE as in claim 14, wherein said adjacent carrier information comprises location of PDCCH.

16. The UE as in claim 13, wherein said UE is configured to identify said added information which is appended to said PDCCH of said current carrier.

17. The UE as in claim 13, wherein said UE is configured to identify PDCCH of said current carrier pointing to PDCCH of first carrier allocated by said base station, when said current carrier is last carrier allocated by said base station.

18. The UE as in claim 13, wherein said UE is configured to identify said added information which is added as a sequence within said PDCCH.

19. The UE as in claim 13, wherein said UE is configured to descramble said information, when said information is added as a scrambled sequence within said PDCCH.
